(19) United States
(12) Patent Application Publication
(10) Pub. No.: US 2015/0074496 A1
(43) Pub. Date: Mar. 12, 2015

(54) MEMORY CONTROLLER, STORAGE DEVICE, AND MEMORY CONTROL METHOD

(71) Applicant: Kabushiki Kaisha Toshiba, Minato-ku (JP)

(72) Inventors: Osamu TORII, Setagaya-ku (JP); Naoaki Kokubun, Yokohama-shi (JP)

(73) Assignee: Kabushiki Kaisha Toshiba, Minato-ku (JP)

(21) Appl. No.: 14/198,817

(22) Filed: Mar. 6, 2014

Related U.S. Application Data
(60) Provisional application No. 61/875,783, filed on Sep. 10, 2013.

(51) Int. Cl. G06F 11/10

(52) U.S. Cl. CPC G06F 11/1072
USPC 714/773

(57) ABSTRACT

According to one embodiment, a memory controller is provided, the memory controller including an encoding unit that performs 1^{st} stage error-correction coding on 1^{st} data, performs 2^{nd} stage error-correction coding on 2^{nd} data, and performs 3^{rd} stage error-correction coding on 3^{rd} data, wherein the 1^{st} data includes 4 sub-unit data included in 1^{st} unit data, the 2^{nd} data includes 4 sub-unit data included in the 1^{st} and 2^{nd} unit data, and the 3^{rd} data includes 4 sub-unit data included in the 1^{st} to 4^{th} unit data.

### CROSS-REFERENCE TO RELATED APPLICATIONS

This application is based upon and claims the benefit of priority from Provisional Patent Application No. 61/875,783, filed on Sep. 10, 2013; the entire contents of which are incorporated herein by reference.

### FIELD

Embodiments described herein relate generally to a memory controller, a storage device, and a memory control method.

### BACKGROUND

There is a method of doubly protecting data stored in a NAND flash memory (hereinafter referred to as a NAND memory) by two-stage error-correction coding.

### BRIEF DESCRIPTION OF THE DRAWINGS

FIG. 1 is a block diagram illustrating an example of a configuration of a semiconductor storage device according to an embodiment.

FIG. 2 is a view illustrating one example of a multi-stage error-correction coding process according to the embodiment.

FIG. 3 is a view illustrating one example of the procedure of the error-correction coding process according to the embodiment.

FIG. 4 is a view illustrating one example of a write format to a semiconductor memory unit.

FIG. 5 is a view illustrating one example of the procedure of the error-correction coding process according to the embodiment.

FIG. 6 is a view illustrating one example of another write format to the semiconductor memory unit.

### DETAILED DESCRIPTION

In general, according to one embodiment, a memory controller according to an embodiment includes an encoding unit which performs 1^{st} stage error-correction coding on 1^{st} data, performs 2^{nd} stage error-correction coding on 2^{nd} data, and performs 3^{rd} stage error-correction coding on 3^{rd} data, the 1^{st} data including 4 sub-unit data included in 1^{st} unit data, the 2^{nd} data including 4 sub-unit data included in the 1^{st} data and 2^{nd} data, and the 3^{rd} data including 4 sub-unit data included in the 1^{st} to 4^{th} unit data.

Exemplary embodiments of a memory controller, a storage device, a memory control method will be explained below in detail with reference to the accompanying drawings. The present invention is not limited to the following embodiments.

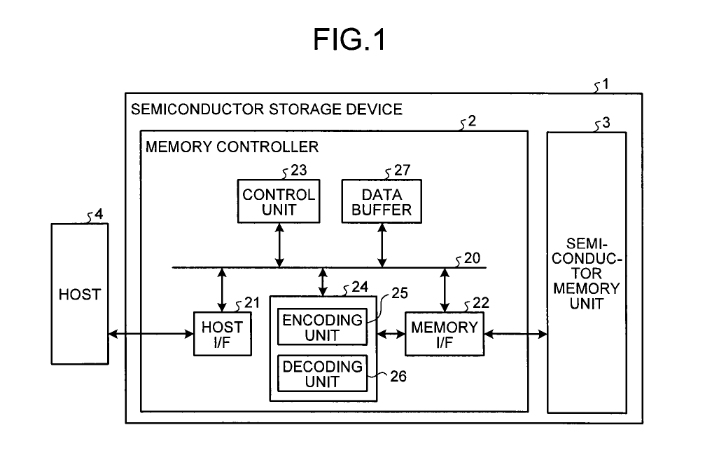

FIG. 1 is a block diagram illustrating an example of a configuration of a storage device (semiconductor storage device) according to the embodiment. A semiconductor storage device 1 according to the present embodiment includes a memory controller 2, and a semiconductor memory unit (non-volatile memory) 3. The storage device 1 is connectable to a host 4. In FIG. 1, a state in which the storage device 1 is connected to the host 4 is shown. The host 4 is, for example, an electronic apparatus such as a personal computer or a mobile terminal.

The semiconductor memory unit 3 is a nonvolatile memory configured to store data in a nonvolatile manner. The semiconductor memory unit 3 is, for example, a NAND memory. In this embodiment, a NAND memory is used as the semiconductor memory unit 3. However, a storage unit other than the NAND memory can be used as the semiconductor memory unit 3. The NAND memory generally writes and reads data in a page unit.

The memory controller 2 controls writing to the semiconductor memory unit 3 in accordance with a write command (request) from the host 4. The memory controller 2 also controls reading from the semiconductor memory unit 3 in accordance with a read command (request) from the host 4. The memory controller 2 includes a Host I/F 21 (first interface unit), a memory I/F (second interface unit) 22, a control unit 23, an encoding/decoding unit 24, and a data buffer 27, these of which are interconnected with an internal bus 20. The encoding/decoding unit 24 includes an encoding unit 25 and a decoding unit 26.

The Host I/F 21 outputs a command or user data received from the host 4 to the internal bus 20. The Host I/F 21 also transmits user data read from the semiconductor memory unit 3 or a response from the control unit 23 to the host 4.

The memory I/F 22 controls a process of writing write data onto the semiconductor memory unit 3 and a process of reading the data from the semiconductor memory unit 3 based upon the instruction from the control unit 23.

The control unit 23 generally controls the memory controller 2. The control unit 23 is a CPU (Central Processing Unit), or MPU (Micro Processing Unit), for example. When receiving a command from the host 4 via the Host I/F 21, the control unit 23 executes a control according to this command. For example, the control unit 23 instructs the memory I/F 22 to write user data and a parity to the semiconductor memory unit 3, or to read user data and a parity from the semiconductor memory unit 3 in accordance with the command from the host 4.

The control unit 23 decides a storage area (memory area) on the semiconductor memory unit 3 to the user data stored in the data buffer 27. The user data is data transmitted from the host 4 as the data to be written onto the semiconductor memory unit 3. The user data is stored in the data buffer 27 via the internal bus 20. The control unit 23 decides the memory area to data on a page basis (page data) that is a writing unit. In the present specification, user data of a predetermined size (first data size) stored in one page of the semiconductor memory unit 3 is defined as unit data. As described later, 1 unit data and parity are stored in 1 page of the semiconductor memory 3 as 1 page data. In the present specification, 1 page of the semiconductor memory 3 indicates a memory area composed of a memory cell group commonly connected to 1 word line. When the memory cell is a single-level cell, the memory cells commonly connected to 1 word line correspond to 1 page. When the memory cell is a multiple level cell, the memory cells commonly connected to 1 word line correspond to plural pages. For example, when a multiple level cell that can store 2 bits is used, the memory cells commonly connected to 1 word line correspond to 2 pages. A physical address is allocated to the memory area in the semiconductor memory 3. The control unit 23 manages the memory area, which is the destination to which the page data is to be written, using the physical address. The control unit 23 instructs the memory I/F 22 to write the user data onto the decided memory area (physical address) in the semiconductor memory unit 3. The control unit 23 manages a correspondence between a logical address (logical address managed by the host 4) and a physical address of user data. When receiving a read command including a logical address from the host 4, the control unit 23 specifies the physical address corresponding to the logical address, and instructs the memory I/F 22 to read the user data from the specified physical address.

The encoding unit 25 executes a multi-stage error-correction coding process to generate a parity based upon the user data stored in the data buffer 27 as described later.

The decoding unit 26 executes a decoding process based upon the user data and the parity read from the semiconductor memory unit 3. In the present embodiment, a multi-stage error-correction decoding process is executed as described later. When the user data has no error (bit error), the decoding unit 26 outputs the user data read from the semiconductor memory unit 3 to the internal bus 20 as it is. When the user data has an error, the decoding unit 26 executes the multi-stage error correction decoding process, and then, outputs the user data to the internal bus 20.

The data buffer 27 temporarily stores the data received from the host 4 until it is stored in the semiconductor memory unit 3. The data buffer 27 also temporarily stores the data read from the semiconductor memory unit 3 until it is transmitted to the host 4. The data buffer 27 is composed of a general-purpose memory such as a SRAM (Static Random Access Memory) or DRAM (Dynamic Random Access Memory).

Next, the multi-stage error-correction coding process (hereinafter merely referred to as “encoding process”) and the multi-stage error-correction decoding process (hereinafter merely referred to as “decoding process”) according to the present embodiment will be described. In the present embodiment, the encoding process is executed in multiple stages including the 1^{st} stage, the 2^{nd} stage, the 3^{rd} stage, and so on. User data inputted in i-th (i is an integer not less than 3) stage coding process is specified as data #i. It is supposed that the data #i is distributed to be stored on kᵢ pages on the semiconductor memory unit 3 (if kᵢ=1, the data is stored in a single page without being distributed). In other words, the encoding unit 25 executes the i-stage (i is an integer not less than 3) encoding process using the user data stored in kᵢ page in the semiconductor memory unit 3. In the present embodiment, the number of pages for the user data inputted in the encoding process is increased in a stepwise manner by establishing kᵢ₊₁>kᵢ.

Any codes may be used as an error correction code used in the encoding process according to the present embodiment. For example, BCH code or RS (Reed-Solomon) code can be used. A different error correction code may be used for each stage, or the same error correction code may be used for all stages.

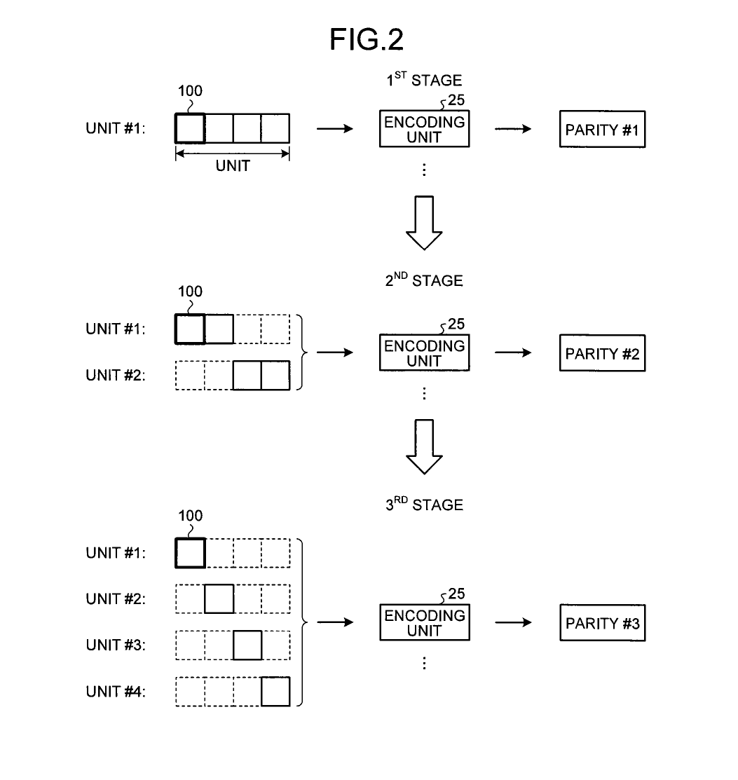

FIG. 2 is a view illustrating one example of the encoding process according to the present embodiment. FIG. 2 illustrates that 3-stage encoding process is executed, wherein user data stored in 1 page is used in the 1^{st} stage, user data stored in 2 pages is used in the 2^{nd} stage, and user data stored in 4 pages is used in the 3^{rd} stage (k₁=1, k₂=2, k₃=4), as one example.

The user data stored in the semiconductor memory unit 3 is temporarily stored in the data buffer 27. The storage area (physical address) on the semiconductor memory unit 3 is allocated to each unit data of the user data in the data buffer 27. The unit data in the data buffer 27 and the page in the semiconductor memory unit 3 have one-to-one correspondence, and the control unit 23 manages this correspondence. Specifically, the control unit 23 manages the write user data on the data buffer 27 in the first data size, thereby generating each unit data on the data buffer 27. During the writing process to the semiconductor memory unit 3, the memory I/F 22 controls to write each unit data on the corresponding page in the semiconductor memory unit 3 based upon the instruction from the control unit 23.

As illustrated in FIG. 2, in the 1^{st} stage error-correction coding process, the control unit 23 controls to input the unit #1, which is the user data of the first data size, on the data buffer 27 to the encoding unit 25. The encoding unit 25 executes the encoding process using the input data (the 1^{st} data) to generate a parity #1 (the 1^{st} parity). Although not illustrated, the 1^{st} stage encoding process is similarly executed to the unit data #2, the unit data #3, and the unit data #4 to generate the parity #1.

Next, in the 2^{nd} stage coding process, the control unit 23 controls to input the first half of the unit data #1 and the last half of the unit data #2 (the data indicated by a solid line in the figure for the 2^{nd} stage in FIG. 2) to the encoding unit 25. The first half of the unit data #1 corresponds to later-described 1^{st} and 2^{nd} sub-unit data. The last half of the unit data #1 corresponds to later-described 3^{rd} and 4^{th} sub-unit data. The encoding unit 25 executes the encoding process using the input data (2^{nd} data) to generate a parity #2 (the 2^{nd} parity). Although not illustrated in the figure, the 2^{nd} stage encoding process is similarly executed to the last half of the unit data #1+the first half of the unit data #2, the first half of the unit data #3+the last half of the unit data #4, and the last half of the unit data #3+the first half of the unit data #4 to generate the 2^{nd} parity.

In the 3^{rd} stage encoding process, the control unit 23 specifies the data that is ¼ of each of the unit data #1 to #4 as the sub-unit data, and controls to input the 1^{st} sub-unit data of the unit data #1+the 2^{nd} sub-unit data of the unit data #2+the 3^{rd} sub-unit data of the unit data #3+the 4^{th} sub-unit data of the unit data #4 (the data indicated by the solid line in the figure for the 3^{rd} stage in FIG. 2) to the encoding unit 25. The encoding unit 25 executes the encoding process using the input data (3^{rd} data) to generate a parity #3 (the 3^{rd} parity). Although not illustrated in the figure, the 3^{rd} stage encoding process is similarly executed to the 2^{nd} sub-unit data of the unit data #1+the 3^{rd} sub-unit data of the unit data #2+the 4^{th} sub-unit data of the unit data #3+1^{st} sub-unit data of the unit data #4, the 3^{rd} sub-unit data of the unit data #1+the 4^{th} sub-unit data of the unit data #2+the 1^{st} sub-unit data of the unit data #3+the 2^{nd} sub-unit data of the unit data #4, the 4^{th} sub-unit data of the unit data #1+the 1^{st} sub-unit data of the unit data #2+the 2^{nd} sub-unit data of the unit data #3+the 3^{rd} sub-unit data of the unit data #4, thereby generating the parity #3.

As illustrated in FIG. 2, focusing on sub-unit data 100 that is the 1^{st} sub-unit data of the unit data #1, the sub-unit data 100 serves as the input data during the generation of the parity #1, the parity #2, and the parity #3. Therefore, the sub-unit data 100 is protected by 3 parities, which are the parity #1, the parity #2, and the parity #3. Similarly, all sub-unit data in the unit data #1 to #4 are protected by 3 parities, which are the parity #1, the parity #2, and the parity #3. In other words, the parity #1, the parity #2, and the parity #3 are generated to all of the unit data #1, the unit data #2, and the unit data #3. FIG. 2 illustrates that plural data protected by the parity #1 are not overlapped in the encoding processes of each stage. However, the plural data protected by the parity #1 may be overlapped. The same applies to the parity #2 and the parity #3. For example, in the 2^{nd} stage encoding process, the parity #2 is generated using the 1^{st} to 3^{rd} sub-units in the unit #1, and the 2^{nd} to 4^{th} sub-units in the unit #2, and the parity #2 is also generated using the 2^{nd} to 4^{th} sub-units of the unit #1 and the 1^{st} to 3^{rd} sub-units of the unit #2.

As illustrated in FIG. 2, the input data in the 3^{rd} stage encoding process is generated from the sub-unit data belonging to each of the unit data #1 to #4. The control unit 23 generates the input data in the 1^{st} stage encoding process from 1 unit data out of 4 unit data, and generates the input data in the 2^{nd} stage encoding process from two unit data out of 4 unit data.

The combination (the combination of sub-unit data in FIG. 2) of the input data in the encoding process of each stage is not limited to that illustrated in FIG. 2. For example, the parity #2 may be generated using the 1^{st} and 3^{rd} sub-unit data of the unit data #1 and the 2^{nd} and 4^{th} sub-unit data in the unit data #2, and the parity #2 may be generated using the 2^{nd} and 4^{th} sub-unit data of the unit data #1 and the 1^{st} and 3^{rd} sub-unit data of the unit data #2, and so on.

FIG. 2 illustrates that the number of stages is 3, and kᵢ=2ⁱ⁻¹ is established. However, the number of stages in the encoding process is not limited to 3, and the value of kᵢ in each stage is not limited to that in FIG. 2, so long as it satisfies kᵢ₊₁>k. For example, the number of stages may be set as 4, and equations of k₁=1, k₂=2, k₃=3, and k₄=4 may be established. In FIG. 2, the size of the input data in each stage is the same (the size corresponding to 1 unit). However, the size of the input data for each stage may be the same or may be different from one another. In the present embodiment, the error correction capability (bit number that can be corrected) in each stage is equal. However, the error correction capability in each stage may be the same or may be different. When the size of the input data in each stage is the same, and the error correction capability in each stage is the same, the encoding process in all stages can be executed by a single encoding processing circuit, whereby a hardware configuration can be simplified.

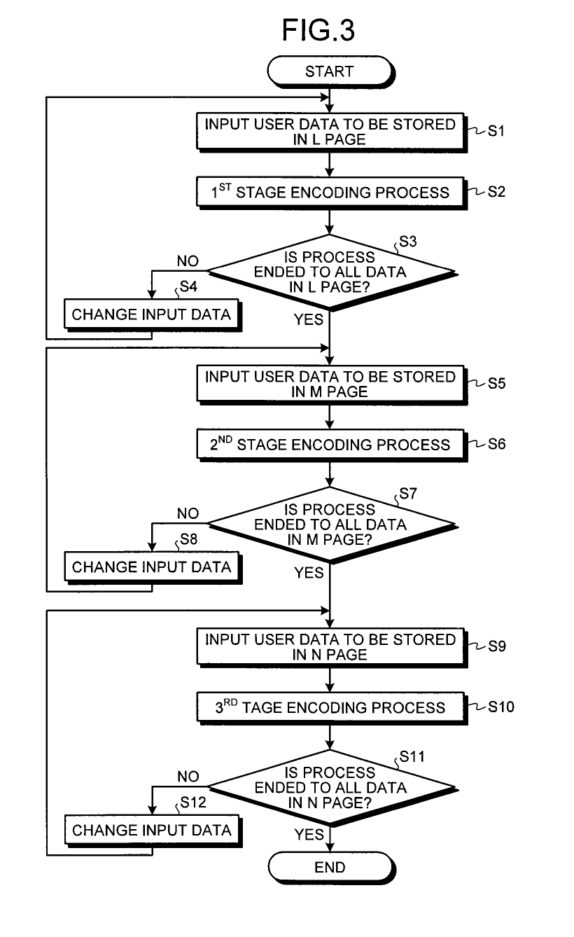

FIG. 3 is a view illustrating one example of the procedure of the encoding process according to the present embodiment. FIG. 3 illustrates that the number of stages is 3, and the equations of k₁=L, k₂=M, and k₃=N are established. Note that L<M<N is established. In this case, k₃=N when data of N pages is encoded, but k₃ may be less than N. For example, when data of 10 pages is encoded, it may be set as k₁=1, k₂=2, and k₃=4 (<10). The control unit 23 controls to input the user data (user data partly extracted from each of L unit data) stored on L page of the semiconductor memory unit 3 to the encoding unit 25 (step S1). The control unit 23 instructs the encoding unit 25 to execute the 1^{st} stage encoding process. The encoding unit 25 executes the 1^{st} stage encoding process to generate the parity #1 (step S2). The control unit 23 checks whether the 1^{st} stage encoding process is ended or not for all data in L pages on the semiconductor memory unit 3 (step S3). When there is data to which the encoding process is not ended out of data in L pages (step S3, No), the control unit 23 changes the input data for the encoding process (step S4), and then, returns to step S1.

When the 1^{st} stage error-correction coding process is ended to all data in L pages (step S3, Yes), the control unit 23 controls to input the user data (user data partly extracted from each of M unit data) stored in M pages of the semiconductor memory unit 3 to the encoding unit 25 (step S5). The control unit 23 instructs the encoding unit 25 to execute the 2^{nd} stage coding process. The encoding unit 25 executes the 2^{nd} stage encoding process to generate the parity #2 (step S6). The control unit 23 checks whether the 2^{nd} stage encoding process is ended or not for all data in M pages on the semiconductor memory unit 3 (step S7). When there is data to which the encoding process is not ended out of data in M pages (step S7, No), the control unit 23 changes the input data for the encoding process (step S8), and then, returns to step S5.

When the 2^{nd} stage error-correction coding process is ended to all data in M pages (step S7, Yes), the control unit 23 controls to input the user data (user data partly extracted from each of N unit data) stored in N pages of the semiconductor memory unit 3 to the encoding unit 25 (step S9). The control unit 23 instructs the encoding unit 25 to execute the 3^{rd} stage encoding process. The encoding unit 25 executes the 3^{rd} stage encoding process to generate the parity #3 (step S10). The control unit 23 checks whether the 3^{rd} stage encoding process is ended or not for all data in N pages on the semiconductor memory unit 3 (step S11). When there is data to which the encoding process is not ended out of data in N pages (step S11, No), the control unit 23 changes the input data for the encoding process (step S12), and then, returns to step S9.

When the 3^{rd} stage error-correction coding process is ended to all data in N pages (step S11, Yes), the control unit 23 ends the encoding process.

According to the above procedure, the parity #1, the parity #2, and the parity #3 are generated. The parity #1, the parity #2, and the parity #3 are written on the semiconductor memory unit 3 together with the user data.

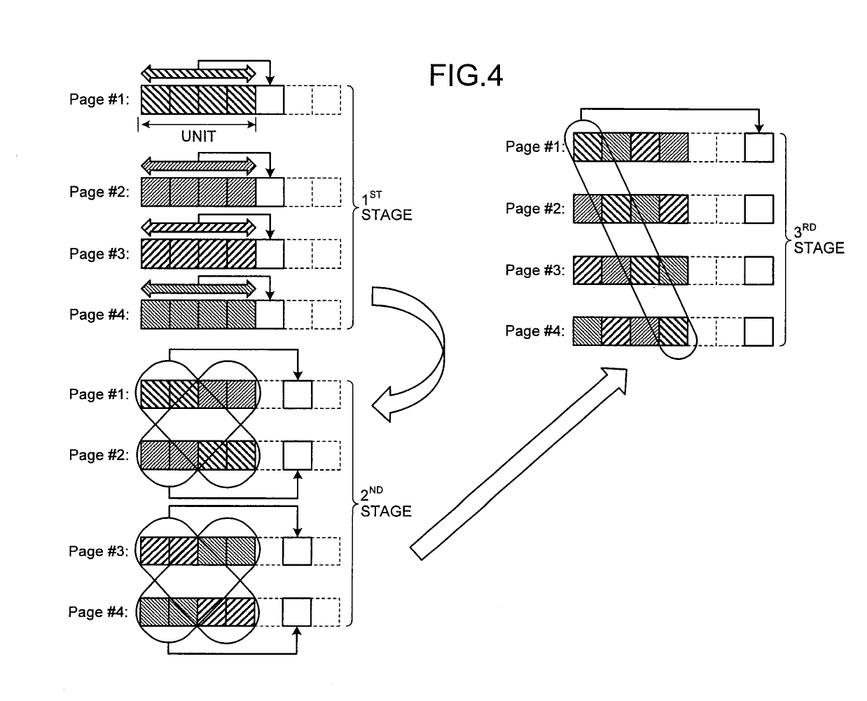

FIG. 4 is a view illustrating one example of a writing format to the semiconductor memory unit 3. FIG. 4 illustrates one example of the writing format to the semiconductor memory unit 3 when 3-stage encoding process is executed according to the procedure illustrated in FIG. 2. As illustrated in FIG. 4, the unit data #1, #2, #3, and #4 illustrated in FIG. 2 are stored in Pages #1, #2, #3, and #4, respectively.

The parity #1 generated using the unit data #1 is stored in the Page #1, the parity #1 generated using the unit data #2 is stored in the Page #2, the parity #1 generated using the unit data #3 is stored in the Page #3, and the parity #1 generated using the unit data #4 is stored in the Page #4.

The parity #2 generated using the first half of the unit data #1+the last half of the unit data #2 is stored in the Page #1, and the parity #2 generated using the last half of the unit data #1+the first half of the unit data #2 is stored in the Page #2. The parity #2 generated using the first half of the unit data #3+the last half of the unit data #4 is stored in the Page #3, and the parity #2 generated using the last half of the unit data #3+the first half of the unit data #4 is stored in the Page #4.

The parity #3 generated using the 1^{st} sub-unit data of the unit data #1+the 2^{nd} sub-unit data of the unit data #2+the 3^{rd} sub-unit data of the unit data #3+the 4^{th} sub-unit data of the unit data #4 is stored in the Page #1. The other parities #3 that are not illustrated with an arrow for simplification are also stored in the Pages #2, #3, and #4, respectively.

FIG. 4 is only illustrative, and the writing format to the semiconductor memory unit 3 is not limited to that in FIG. 4. Since the reading from the semiconductor memory unit 3 is executed on the page basis, it is desirable that the parity #1 is stored in the page from which the user data is read. This storage manner realizes that, when an error is not found or an error can be corrected by the 1^{st} stage decoding process using the parity #1 during the reading process of reading the data in the page that is to be read, the reading process can be ended without a need to read other pages. Similarly, the parities #2 and #3 can be stored in the page from which the user data is read, but since the parities #2 and #3 are less frequently used than the parity #1 during the reading process, they may be stored in a parity exclusive page that is provided.

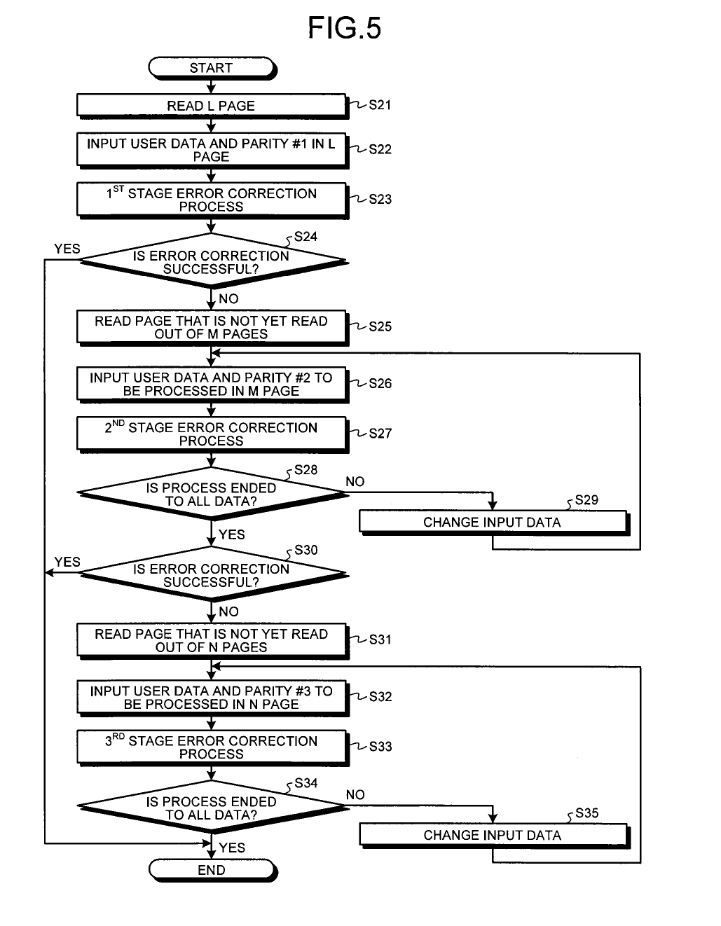

FIG. 5 is a view illustrating one example of the procedure of the decoding process according to the present embodiment. In FIG. 5, the number of stages is 3, and the equations of k₁=L, k₂=M, and k₃=N are established, as in FIG. 3. Firstly, the control unit 23 instructs the memory I/F 22 to read the page to be read (L page) from the semiconductor memory unit 3 (step S21). The user data in L page read from the semiconductor memory unit 3 and the parity #1 are inputted to the decoding unit 26 (step S22). The control unit 23 instructs the decoding unit 26 to execute the 1^{st} stage decoding process (step S23). The decoding unit 26 executes the 1^{st} stage decoding process using the user data and the parity #1, and notifies the control unit 23 of whether the error correction is successful or not. The case where an error is not found is included in the case where the error correction is successful.

The control unit 23 checks whether the error correction is successful or not by the 1^{st} stage decoding process (step S24). When the error correction is unsuccessful (step S24, No), the control unit instructs the memory I/F 22 to read a page that is not yet read in M pages (step S25). The M page has stored therein the user data from which the parity #2 that is to protect the user data in the L page to be read is generated. This user data is distributed to be stored in the M page.

The control unit 23 inputs a set of user data and the parity #2, among the sets of user data and the parities #2 of the read M page, to the decoding unit 26 (step S26). The control unit 23 instructs the decoding unit 26 to execute the 2^{nd} stage decoding process (step S27). The decoding unit 26 executes the 2^{nd} stage decoding process using the inputted user data and the parity #2, and notifies the control unit 23 of whether the error correction is successful or not.

The control unit 23 checks whether the process is ended to all sets of the user data and the parity #2 in the M page (step S28). When there is the set to which the process is not ended (step S28, No), the control unit 23 changes the input data of the decoding unit 26 (step S29), and returns to step S26. When the process is ended to all sets of the user data and the parity #2 in the M page (step S28, Yes), the control unit 23 checks whether the error correction is successful or not by the 2^{nd} stage decoding process (step S30). In step S30, it is checked that the error correction is successful when the error correction is successful to all sets of the user data and the parity #2 in the M page, and if there is only one set to which the error correction is unsuccessful, it is checked that the error correction is unsuccessful.

When the control unit 23 checks in step S30 that the error correction is unsuccessful (step S30, No), it instructs the memory I/F 22 to read the page that is not yet read, among the N pages (step S31). The N page has stored therein the user data from which the parity #3 that is to protect the user data in the L page to be read is generated. This user data is distributed to be stored in the N page.

The control unit 23 inputs a set of the user data and the parity #3, among the user data and the parities #3 in the read N page, to the decoding unit 26 (step S32). The control unit 23 instructs the decoding unit 26 to execute the 3^{rd} stage decoding process (step S33). The decoding unit 26 executes the 3^{rd} stage decoding process, and notifies the control unit 23 of whether the error correction is successful or not.

The control unit 23 checks whether the process is ended to all sets of the user data and the parity #3 in the N pages (step S34). When there is the set to which the process is not ended (step S34, No), the control unit 23 changes the input data of the decoding unit 26 (step S35), and returns to step S32. When the process is ended to all sets in step S34 (step S34, Yes), the control unit 23 ends the process.

When checking in step S24 that the error correction is successful (step S24, Yes), or when checking in step S30 that the error correction is successful (step S30, Yes), the control unit 23 ends the process. When the error correction is successful by the 1^{st} stage error decoding process, the control unit 23 transfers the user data corrected by the 1^{st} stage decoding process (when there is no error, the user data read from the semiconductor memory unit 3) to the host 4. When the error correction is successful by the 2^{nd} stage error decoding process, the control unit 23 transfers the user data to be read, among the user data corrected by the 2^{nd} stage decoding process, to the host 4. When the error correction is successful by the 3^{rd} stage error decoding process, the control unit 23 transfers the user data to be read, among the user data corrected by the 3^{rd} stage decoding process, to the host 4. When the error cannot be corrected even by the 3^{rd} stage decoding process, the control unit 23 executes a predetermined process such as a process of giving notification of this situation to the host 4.

In the description above, the 1^{st} stage decoding process, the 2^{nd} stage decoding process, and the 3^{rd} stage decoding process are each executed at most once. However, when the 1^{st} stage decoding process is again executed after the result of the 2^{nd} stage decoding process is reflected, an error might be capable of being corrected. Similarly, when the 1^{st} stage decoding process is again executed after the result of the 3^{rd} stage decoding process is reflected, an error might be capable of being corrected. The probability of correcting an error can be improved by repeatedly executing the decoding process in each stage. Therefore, all of the processes in steps S23 to S34 in FIG. 5 may be repeated. This repetition is ended after a predetermined number of times of the repetition are executed, or when only 1 bit cannot newly be corrected by the processes in steps S25 to S34, for example.

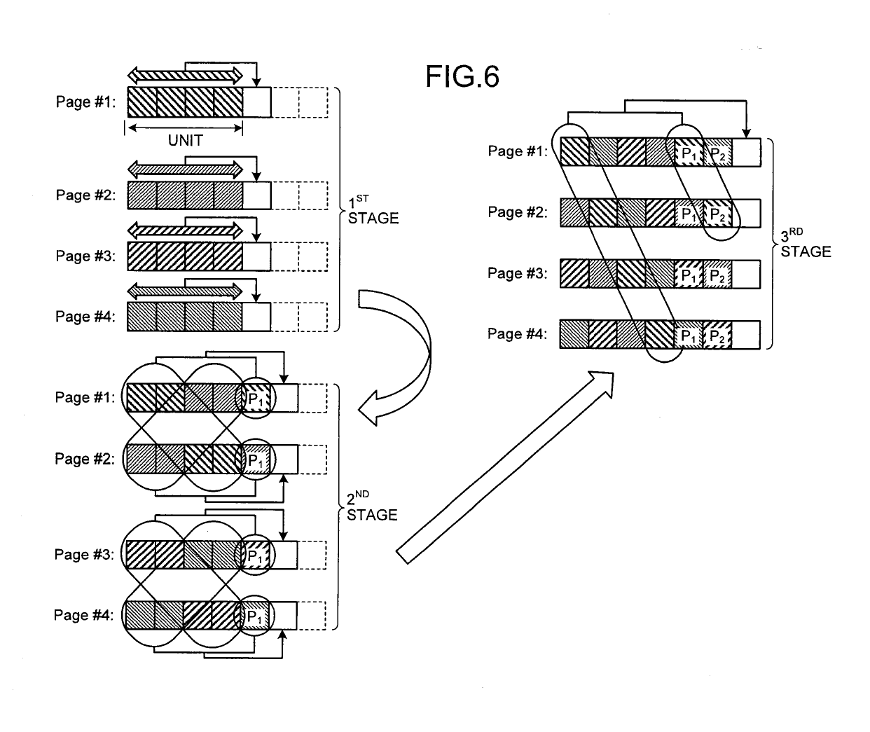

In the description above, the user data is triply protected by three types of different parities. Each parity may be multiply protected. FIG. 6 is a view illustrating one example of a writing format to the semiconductor memory unit 3 when parity is multiply protected. P₁ in FIG. 1 indicates the 1^{st} parity, and P₂ indicates the 2^{nd} parity. As illustrated in FIG. 6, in the 2^{nd} stage encoding process, the 2^{nd} parity is generated using 4 sub-unit data and the 1^{st} parity described in FIG. 4. In FIG. 6, the 2^{nd} parity is generated using the first half of the unit data #1, the last half of the unit data #2, and the 1^{st} parity stored in the page #1, which are similarly hatched. In the 3^{rd} stage encoding process, the 3^{rd} parity is generated using 4 sub-unit data, the 1^{st} parity, and the 2^{nd} parity. Thus, the 1^{st} parity is protected by the 2^{nd} parity and the 3^{rd} parity, and the 2^{nd} parity is protected by the 3^{rd} parity.

FIG. 6 is only an example. The 2^{nd} parity may be generated using the first half of the unit data #1, the last half of the unit data #2, and the 1^{st} parity stored in the page #2, for example. The combination of data and parity serving as the input in the encoding process is not limited to those in FIG. 6. In FIG. 6, the 1^{st} parity is protected by both the 2^{nd} parity and the 3^{rd} parity. However, the 2^{nd} parity may be excluded from the 3^{rd} stage encoding process, and the 1^{st} parity may be protected by the 3^{rd} parity.

As described above, in the present embodiment, the encoding process is executed in each of three or more stages to generate parity for each stage, wherein 1 user data is protected by parities in all stages, and i-th parity is distributed and stored in kᵢ page, satisfying kᵢ₊₁>kᵢ, on the semiconductor memory unit 3 (when kᵢ=1, the user data is stored in a single page without being distributed). In other words, when user data of the first data size is specified as the unit data, the parity in i-th stage is generated using the user data extracted at least partly from kᵢ unit data, and each unit data is stored in a different page on the semiconductor memory unit 3. For example, when the 3^{rd} stage encoding process is executed, the parity #1 is generated using the user data extracted at least partly from L unit data, the parity #2 is generated using the user data extracted at least partly from M (M>L) unit data, and the parity #3 is generated using the user data extracted at least partly from N (N>M) unit data. Thus, each bit of the user data is protected by the parity #1, the parity #2, and the parity #3. Accordingly, the error correction capability according to the number of error bits included in each unit data can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory controller which controls a non-volatile memory, the memory controller comprising:
a first interface unit which receives write command and write-data;
an encoding unit which performs 1^{st}, 2^{nd}, and 3^{rd} stage encodes, the 1^{st} stage encode comprising encoding on 1^{st} data to generate 1^{st} parity, the 2^{nd} stage encode comprising encoding on 2^{nd} data to generate 2^{nd} parity, and the 3^{rd} stage encode comprising encoding on 3^{rd} data to generate 3^{rd} parity, the 1^{st} data comprising 4 sub-unit data included in 1^{st} unit data, the 2^{nd} data comprising 4 sub-unit data chosen from a plurality of sub-unit data included in the 1^{st} unit data and a plurality of sub-unit data included in 2^{nd} unit data, the 3^{rd} data comprising 4 sub-unit data chosen from a plurality of sub-unit data included in the 1^{st} unit data, a plurality of sub-unit data included in the 2^{nd} unit data, a plurality of sub-unit data included in 3^{rd} unit data and a plurality of sub-unit data included in 4^{th} unit data, and the 1^{st} unit data, the 2^{nd} unit data, the 3^{rd} unit data and the 4^{th} unit data being the write-data; and
a second interface unit which causes the non-volatile memory to store the 1^{st} unit data, the 2^{nd} unit data, the 3^{rd} unit data, the 4^{th} unit data, the 1^{st} parity, the 2^{nd} parity, and the 3^{rd} parity.

2. The memory controller according to claim 1, wherein the non-volatile memory comprises a first group of memory cells and a first word line, the first group of memory cells being commonly connected to the first word line, wherein the second interface unit causes the non-volatile memory to store the 1^{st} unit data, the 1^{st} parity, the 2^{nd} parity and the 3^{rd} parity in the first group of memory cells.

3. The memory controller according to claim 1, wherein
the non-volatile memory comprises a first group of memory cells, a second group of memory cells, a first word line, and a second word line, the first group of memory cells being commonly connected to the first word line, and the second group of memory cells being commonly connected to the second word line, and
the second interface unit causes the non-volatile memory to write at least one of the 1^{st} to 4^{th} unit data in the first group of memory cells, and to write at least one of the 1^{st} to 4^{th} unit data, other than the unit data written in the first group of memory cells, in the second group of memory cells.

4. The memory controller according to claim 1, wherein the second data is composed of 4 sub-unit data in total chosen from the 1^{st} unit and the 2^{nd} unit in order to include at least 1sub-unit chosen from the 1^{st} unit data and at least 1sub-unit chosen from the 2^{nd} unit data, and the 3^{rd} data is composed of 4 sub-unit in total each chosen from the 1^{st} unit data, the 2^{nd} unit data, the 3^{rd} unit data, and the 4^{th} unit data.

5. The memory controller according to claim 1, further comprising a decoding unit which performs 1^{st} stage decode, the 1^{st} stage decode comprising decoding on the 1^{st} unit data using the 1^{st} unit data and the 1^{st} parity.

6. The memory controller according to claim 3, wherein the decoding unit further performs 2^{nd} stage decode when the 1^{st} stage decode fails, the 2^{nd} stage decode comprising decoding on the 2^{nd} data using the 2^{nd} data and the 2^{nd} parity.

7. The memory controller according to claim 4, wherein the decoding unit further performs 3^{rd} stage decode when the 2^{nd} stage decode fails, the 3^{rd} stage decode comprising decoding on the 3^{rd} data using the 3^{rd} data and the 3^{rd} parity.

8. The memory controller according to claim 1, wherein error correction capability in an encoding method used in the 1^{st} sage encode, the 2^{nd} stage encode, and the 3^{rd} stage encode is equal.

9. The memory controller according to claim 1, wherein the 2^{nd} data further includes the 1^{st} parity, and the 3^{rd} data further includes one or more of the 1^{st} parity and the 2^{nd} parity.

10. A memory controller which controls a non-volatile memory, the memory controller comprising:
a first interface unit which receives write command and write-data;
an encoding unit which performs 1^{st} , 2^{nd} and 3^{rd} stage encodes, the 1^{st} stage encode comprising encoding on 1^{st} data to generate 1^{st} parity, the 2^{nd} stage encode comprising encoding on 2^{nd} data to generate 2^{nd} parity, and the 3^{rd} stage encode comprising encoding on 3^{rd} data to generate 3^{rd} parity, the 1^{st} data comprising a plurality of sub-unit data chosen from each of L unit data, the 2^{nd} data comprising a plurality of sub-unit data chosen from each of M unit data, the 3^{rd} data comprising a plurality of sub-unit data chosen from each of N unit data, N being an integer satisfying L<M<N, and the unit data being the write-data; and
a second interface unit which causes the non-volatile memory to store the unit data, the 1^{st} parity, the 2^{nd} parity, and the 3^{rd} parity.

11. The memory controller according to claim 10, wherein
the non-volatile memory comprises a first group of memory cells and a first word line, the first group of memory cells being commonly connected to the first word line, and
the second interface unit causes the non-volatile memory to write one of the unit data composing the 1^{st} data, the 1^{st} parity, the 2^{nd} parity and the 3^{rd} parity in the first group of memory cells.

12. The memory controller according to claim 10, wherein
the non-volatile memory comprises a first group of memory cells, a second group of memory cells, a first word line, and a second word line, the first group of memory cells being commonly connected to the first word line, and the second group of memory cells being commonly connected to the second word line, and
the second interface unit causes the non-volatile memory to write at least one of L unit data in the first group of memory cells, and to write at least one of the L unit data, other than the unit data written in the first group of memory cells, in the second group of memory cells.

13. The memory controller according to claim 10, further comprising a decoding unit which performs 1^{st} stage decode, the 1^{st} stage decode comprising decoding on the 1^{st} unit data using the 1^{st} unit data and the 1^{st} parity.

14. The memory controller according to claim 11, wherein the decoding unit further performs 2^{nd} stage decode when the 1^{st} stage decode fails, the 2^{nd} stage decode comprising decoding on the 2^{nd} data using the 2^{nd} data and the 2^{nd} parity.

15. The memory controller according to claim 14, wherein the decoding unit further performs 3^{rd} stage decode when the 2^{nd} stage decode fails, the 3^{rd} stage decode comprising decoding on the 3^{rd} data using the 3^{rd} data and the 3^{rd} parity.

16. The memory controller according to claim 10, wherein error correction capability in an encoding method used in the 1^{st} sage encode, the 2^{nd} stage encode, and the 3^{rd} stage encode is equal.

17. The memory controller according to claim 10, wherein the ith data further includes one or more of the 1^{st} to (i−1)th parity.

18. A storage device comprising:
a non-volatile memory;
a first interface unit which receives write command and write-data;
an encoding unit which performs 1^{st}, 2^{nd}, and 3^{rd} stage encodes, the 1^{st} stage encode comprising encoding on 1^{st} data to generate 1^{st} parity, the 2^{nd} encode comprising encoding on 2^{nd} data to generate 2^{nd} parity, and the 3^{rd} stage encode comprising encoding on 3^{rd} data to generate 3^{rd} parity, the 1^{st} data comprising 4 sub-unit data included in 1^{st} unit data, the 2^{nd} data comprising 4 sub-unit data chosen from a plurality of sub-unit data included in the 1^{st} unit data and a plurality of sub-unit data included in 2^{nd} unit data, the 3^{rd} data comprising 4 sub-unit data chosen from a plurality of sub-unit data included in the 1^{st} unit data, a plurality of sub-unit data included in the 2^{nd} unit data, a plurality of sub-unit data included in 3^{rd} unit data, and a plurality of sub-unit data included in 4^{th} unit data, and the 1^{st} unit data, the 2^{nd} unit data, the 3^{rd} unit data, and the 4^{th} unit data being the write-data; and
a second interface unit which causes the non-volatile memory to store the 1^{st} unit data, the 2^{nd} unit data, the 3^{rd} unit data, the 4^{th} unit data, the 1^{st} parity, the 2^{nd} parity, and the 3^{rd} parity.

19. A memory control method in a memory controller which controls a non-volatile memory, the method comprising:
receiving write command and write-data;
performing 1^{st} stage encode on 1^{st} data to generate 1^{st} parity;
performing 2^{nd} stage encode on 2^{nd} data to generate 2^{nd} parity;
performing 3^{rd}stage encode on 3^{rd} data to generate 3^{rd} parity;
wherein
the 1^{st} data comprises 4 sub-unit data included in 1^{st} unit data, the 2^{nd} data comprises 4 sub-unit data chosen from a plurality of sub-unit data included in the 1^{st} unit data and a plurality of sub-unit data included in 2^{nd} unit data, the 3^{rd} data comprises 4 sub-unit data chosen from a plurality of sub-unit data included in the 1^{st} unit data, a plurality of sub-unit data included in the 2^{nd} unit data, a plurality of sub-unit data included in 3^{rd} unit data, and a plurality of sub-unit data included in 4^{th} unit data, and the 1^{st} unit data, the 2^{nd} unit data, the 3^{rd} unit data, and the 4^{th} unit data are the write-data; and
causing the non-volatile memory to store the 1^{st} unit data, the 2^{nd} unit data, the 3^{rd} unit data, the 4^{th} unit data, the 1^{st} parity, the 2^{nd} parity, and the 3^{rd} parity.
